(19) United States
(12) Patent Application Publication
(10) Pub. No.: US 2007/0051879 A1
(43) Pub. Date: Mar. 8, 2007

(54) Image Intensifier Device and Method

(76) Inventors: Tal Kuzniz, Ariel (IL); Iddo Pinkas, Rchovot (IL)

Correspondence Address: APPLIED MATERIALS, INC.;C/O SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/460,575

(22) Filed: Jul. 27, 2006

Related U.S. Application Data
(60) Provisional application No. 60/715,900, filed on Sep. 8, 2005.

(51) Int. Cl. H01J 43/30; H01J 31/50

(52) U.S. Cl. 250/214 VT; 250/207

(57) ABSTRACT

An image intensifier device includes a photocathode unit having an active region adapted to convert light to electrons; a luminescent screen unit adapted to convert electrons emitted from the photocathode unit to light while generating ions; and a charge particle control unit. The latter is adapted to direct electrons from the photocathode unit towards the luminescent screen unit while substantially preventing the generated ions to reach at least the active region of the photocathode unit.

### RELATED APPLICATION

This application is a NONPROVISIONAL of, claims priority to and incorporates by reference U.S. Provisional Patent Application 60/715,900, filed 8 Sep. 2005.

### FIELD OF THE INVENTION

This invention relates to image intensifiers, and particularly to magnetically focused image intensifiers.

### BACKGROUND

Image intensifiers are widely used for sensing and amplifying, or intensifying, light images of low intensity. In these devices, light (usually of visible or near infra-red spectra) from an associated optical system is directed onto a photocathode which emits a distribution of photoelectrons in response to the input radiation.

Image intensifiers typically include a vacuum tube with a photocathode at one end and a phosphor screen at the other end, the photocathode converts incoming photons to electrons which are accelerated by an electric filed (potential difference) in the tube until they hit the phosphor screen converting them back to photons.

There are several known types of image intensifiers: The so-called “first generation image intensifiers” are intensifier diodes that utilize only a single potential difference to accelerate electrons from the cathode to the anode (screen) In this intensifiers, focusing is achieved by two methods: by placing the phosphor screen in close proximity to the photocathode (proximity diode), or by using an electrostatic or magnetic focus approach, namely using an electron lens to focus electrons originating from the photocathode onto the screen (inverter diode or magnetically focused diode). The “second generation image intensifiers” utilize electron multipliers, i.e., not only the energy but also the number of electrons between input and output is significantly increased. Multiplication is achieved by use of a device called microchannel plate (MCP), i.e. a thin plate of conductive glass containing many small holes. In these holes, secondary electron emission occurs which leads to multiplication factors of up to four orders of magnitude. The “third generation image intensifiers” employ MCP intensifiers with Gallium-Arsenide photocathodes (instead of multialkali photocathodes normally used in first and second generation intensifiers) to increase a luminous sensitivity of approximately 1.200 μA/lm instead of 300 μA/lm found in the multialkali photocathodes. These GaAs photocathodes are also much more sensitive in the NIR region of the light spectrum.

A magnetically focused image intensifier is described for example in U.S. Pat. No. 4,070,574. Here, an improvement is suggested for increasing the usable range of magnification without degradation of image quality and while keeping to a minimum the power requirements of the focusing coils. An arrangement of focusing coils is used which reverses the direction of the axial magnetic field distribution between the planes of the photocathode and the phosphor screen.

Image intensifiers are used in various imaging and inspection systems, including those used in semiconductor industry for manufacturing integrated circuits. In such systems, an image intensifier is appropriately located in front of a light detector (e.g. CMOS camera). Such systems are disclosed for example in U.S. Pat. No. 6,661,508; EP 305644 and US 2005/0219518 all assigned to the assignee of the present application, and U.S. Pat. No. 4,755,874.

### SUMMARY OF THE INVENTION

There is a need in the art for an image intensifier enabling increase of the lifetime of its photocathode.

The photocathode lifetime parameter is mostly affected by ions hitting the photocathode. Ions are unavoidably created in an image intensifier, being originated at the phosphor screen as a result of hitting by an electron beam from the photocathode. This is the so-called “ion feedback” in the device.

The invention provides a device and method that reduce and even prevent ion feedback. The device and method reduce the amount of ions that interact with the active region of the photocathode. It should be understood that the term “active region ” refers to a photocathode layer region exposed to input light and thus capable of converting the incident light into emitted electrons. This active region is to be protected from being damaged by ions. Thus, according to the invention, the amount of ions that interact with the active region is substantially decreased.

The lifetime of photocathode used in an image intensifier is an important parameter in general, and essential for various applications. An example of such applications is the use of an image intensifier in automatic inspection systems, e.g. wafer inspection. Examples of such systems utilizing image intensifiers in front of light detectors are disclosed in the above indicated patent publications U.S. Pat. No. 6,661,508; EP 305644 and US 2005/0219518 assigned to the assignee of the present application, and also in U.S. Pat. No. 4,755,874.

The automatic inspection systems are aimed at inspecting articles (e.g. wafers) progressing along a production line, and thus the image intensifier is to efficiently operate for a long time. Keeping in mind that the lifetime of a photocathode is an important parameter and that the ions creation is an unavoidable factor in image intensifiers, the invention provides for increasing the throughput of the production line by increasing the lifetime of the photocathode used in the image intensifier being a part of the automatic inspection system.

According to one broad aspect of the invention, there is provided an image intensifier comprising: a photocathode unit having an active region adapted to convert light to electrons; a luminescent screen unit adapted to convert electrons emitted from the photocathode unit to light while generating ions; and a charge particle control unit adapted to direct electrons from the photocathode unit towards the luminescent screen unit while substantially preventing the generated ions to reach at least the active region of the photocathode unit.

According to another broad aspect of the invention, there is provided a method for increasing a lifetime of a photocathode in an image intensifier device, which includes a photocathode unit adapted to convert light to electrons and a luminescent screen unit adapted to convert electrons emitted from the photocathode unit to light while generating ions, the method comprising: providing, in the path of electrons from the photocathode to the luminescent screen unit, a charge particle control unit adapted to direct electrons from the photocathode unit towards the luminescent screen unit while substantially preventing the generated ions to reach at least the active region of the photocathode unit.

Preferably, the image intensifier includes a plurality of apertured electrodes, E₁-Eₙ₋₁, arranged in a spaced-apart substantially parallel relationship along a vacuum tube between the photocathode unit and the luminescent screen unit defining a channel for the electrons propagation from the photocathode to the luminescent screen unit, said plurality of apertured electrodes being maintained at voltages, V₁-Vₙ₋₁, gradually increasing in a direction towards the luminescent screen unit location.

According to some embodiments of the invention, the charge particle control unit (the so-called “ion flow affector or adjustor”) is configured and operable to create an external field preventing the ions propagation to at least the active region of the photocathode.

This can be achieved by creating an electric field profile in the tube directing the ions back to the screen unit, and thus preventing their propagation to the photocathode plane. Considering the use of multiple apertured electrodes in the tube, the charge particle control unit may be constituted by a voltage supply unit configured and operable to supply voltage Vₙ to the luminescent screen unit lower than voltage Vₖ on k-th apertured electrode where n>k, thereby accelerating the ions back to the screen unit. For example, voltage Vₙ₋₁ applied to the apertured electrode Eₙ₋₁ closest to the luminescent screen unit is higher than voltage Vₙ of the screen unit.

The external field appropriately adjusting the ion flow may be the same magnetic focusing field used in the device. This field is created so as to direct the magnetic field vector along an axis forming a certain non-zero angle with an electric field vector created by the electrons flow from the photocathode towards the luminescent screen unit. By this, the ions originated at the luminescent screen unit become directed towards outside the active region of the photocathode. The “tilted” magnetic field vector may be created by appropriately tilting the coils of a magnetic field source with respect to the longitudinal axis of the vacuum tube.

In some other embodiments of the invention, the charge particle control unit includes an ion barrier film (IBF) structure accommodated between the multialkali photocathode and the luminescent screen unit. The IBF is configured to block ions (as well as any gas) incident thereto thus preventing passage of ions from the luminescent screen side of the tube to the photocathode.

In further embodiments of the invention, the image intensifier device is configured to increase the lifetime of a multialkali photocathode by using an electron multiplier (microchannel plate MCP) and possibly also an ion barrier film, accommodated in the path of electrons propagating from the photocathode unit to the luminescent screen unit.

In yet other embodiments of the invention, in the magnetically focused image intensifier device, the charge particle control unit is constituted by an electron multiplier and possibly also an ion barrier film. Such a device may utilize a magnetically focus diode arrangement both at the photocathode-MCP path and at the MCP-screen path; or utilizes the magnetically focus diode arrangement at one of these paths and the proximity diode arrangement at the other of said paths. It should be noted that conventionally the use of a magnetically focus diode is aimed at increasing the device resolution, while the use of an MCP is known as decreasing the resolution. The invention utilizes a combination of the principles of magnetically focus diode arrangement and those of the MCP. This is enabled with practically no decrease in resolution because the invention preferably is used with UV illumination, where resolution is limited mainly by photons dispersion when emerging the vacuum tube and not by the passage through MCP. This is because with UV input the energy of dispersion is about 10 times higher than with other spectral ranges.

Thus according to yet another broad aspect of the invention, there is provided a method for increasing a lifetime of a multialkali photocathode in an image intensifier device, which includes a photocathode unit adapted to convert light to electrons and a luminescent screen unit adapted to convert electrons emitted from the photocathode unit to light while generating ions, the method comprising providing an electron multiplier in the path of electrons propagating from the photocathode unit to the luminescent screen unit.

According to yet further broad aspect of the invention, there is provided a method for increasing a lifetime of a photocathode in a magnetically focused image intensifier device, which includes a photocathode unit adapted to convert light to electrons and a luminescent screen unit adapted to convert electrons emitted from the photocathode unit to light while generating ions, the method comprising providing an electron multiplier in the path of electrons propagating from the photocathode unit to the luminescent screen unit.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram of the main functional elements in an image intensifier device of the present invention;

FIGS. 2A-2D exemplify the configuration and operation of an image intensifier of the invention utilizing an electric field of a specific field profile as a charge particle control unit (or “ion flow affector”), where FIG. 2A shows an example of the vacuum tube configuration, FIG. 2B shows the electric field lines in the vacuum tube of FIG. 2A, FIG. 2C compares the voltage profile along the tube of FIG. 2A with that of the conventional intensifier configuration, and FIG. 2D shows the voltage profile across the tube of FIG. 2A in the vicinity of the phosphor screen;

FIGS. 3A to 3C schematically illustrate the configuration and operation of the image intensifier device according to another example of the invention, utilizing a charge particle control unit in the form of an external diverting magnetic field source, where FIG. 3A schematically illustrates the image intensifier device, and FIGS. 3B and 3C compare the operational principles of device of FIG. 3A (FIG. 3C) to the conventional device of the kind specified (FIG. 3B);

FIGS. 4A to 4C illustrate yet other examples of the image intensifier device of the present; and

FIG. 5 exemplifies an automatic inspection system for inspecting wafers utilizing the image intensifier device of the present invention.

### DETAILED DESCRIPTION

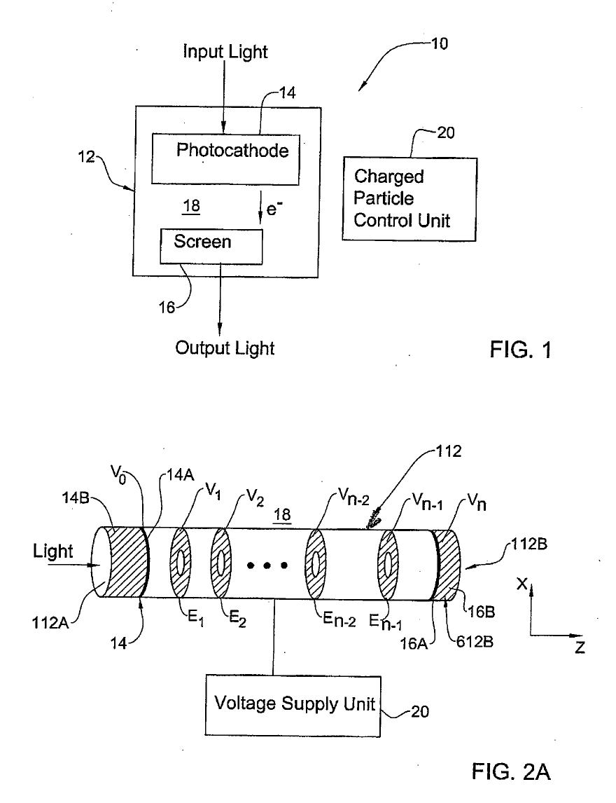

Referring to FIG. 1, there is illustrated by way of a block diagram an example of an image intensifier device 10 of the present invention. Image intensifier device 10 is configured as a magnetically focused “first generation image intensifier” device, namely includes a vacuum tube 12 including spaced-apart photocathode unit 14 (for example including a multialkali photocathode layer) and a luminescent screen unit 16 accommodated in a magnetic field region 18. Photocathode unit 14 has an active region exposed to input light to convert the input light into emitted electrons propagating through the vacuum tube and hitting the luminescent screen unit, thereby causing an intensified light output therefrom. Typically, the luminescent screen consists of a phosphor layer having a backing layer of aluminum. Typically, the electrons-to-light conversion at the phosphor screen originates ions.

Device 10 of the present invention is configured to define a charged particle control mechanism (ion flow affector) 20. The latter is configured and operable to prevent ions originated at phosphor screen 16 (as a result of electrons hitting it) from propagating to the photocathode, at least to its active region. By this, the lifetime of the photocathode is increased.

It should be noted that FIG. 1 is a block diagram illustration of the functional elements of device 10 and does not show a correct relative accommodation of these elements in the device. For example, charged particle control unit 20 is not necessarily located outside the vacuum tube, but may be constituted by physical element(s) inside the tube, as will be exemplified further below. Generally speaking, charged particle control unit 20 may be configured to create an external field preventing the ions from reaching at least the active region of the photocathode, or may be configured to block (absorb) ions on their way towards the photocathode.

The following are several specific but non-limiting examples of the invention. To facilitate understanding, the same reference numerals are used for identifying the common components in all the examples.

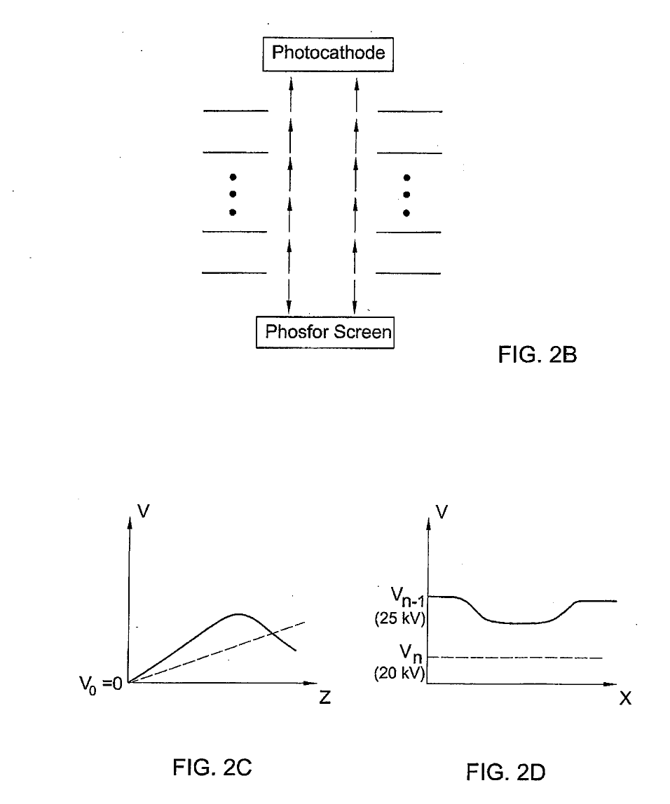

Reference is made to FIG. 2A exemplifying a vacuum tube 112 of the present invention for use in the above-described magnetically focus image intensifier device. To this end, the vacuum tube is typically accommodated in a magnetic field region 18 created by an external magnetic field source (which is not shown here). Vacuum tube 112 includes a chamber with optically transparent (e.g. made of glass) side facets defining a light input 112A and a light output 112B, and contains a photocathode unit 14 at the input end and a phosphor screen unit 16 at the output end. Photocathode unit 14 is formed by a photocathode layer 14A on a glass substrate 14B (input glass facet), and phosphor screen unit 16 includes a phosphor layer 16A on a glass substrate 16B (output glass facet). Photocathode layer 14A material may include bi-alkali or multi alkali materials (Cs, Sb, K, Na), solar blind (CsTe), GaAs. Other photocathodes may also be used. The photocathode is about 10 s of nanometers thick.

Further provided in vacuum tube 112 is a plurality of apertured electrodes (metal disks), E₁-Eₙ₋₁ at locations Z₁-Zₙ₋₁, respectively, arranged in a spaced-apart substantially parallel relationship along the Z-axis of the tube between photocathode and phosphor layers 14A and 16A. The apertures may be substantially round or rectangular. Such disks may be configured as a mesh (silicon etched or metal mesh) of about 3 μm “wire” width and about 100 μm pitch, or just plain hollow disks. The disks (apertures therein) define a channel for the electrons propagation from the photocathode to the phosphor screen.

The apertured electrodes E₁-Eₙ₋₁, as well as photocathode 14 and phosphor screen unit 16, are connected to a voltage supply unit 20. It should be understood that grounding of some of the electrodes in the device is also referred to as associating them with a required voltage supply.

In this example, voltage supply unit 20 constitutes a charged particle control unit operating to create an electric field in the tube preventing the ions, originated at the phosphor screen, from reaching the photocathode. Voltage supply unit 20 operates to apply appropriate voltages V₀ (e.g. V₀=0) and Vₙ(Vₙ>V₀) to, respectively, the photocathode and the phosphor screen so as to provide a certain potential difference between them to thereby create an electric field attracting the flow of electrons emitted at the photocathode towards the phosphor screen. Also, voltage supply unit 20 operates to maintain electrodes E₁-Eₙ₋₁ at voltages V₁-Vₙ₋₁, respectively, gradually increasing in a direction towards the phosphor screen location, V₁<V₂< . . . <Vₙ₋₁, and to provide a condition that Vn<Vk where n>k. In this specific but not limiting example, this effect is implemented by providing Vₙ₋₁>Vₙ, namely electrode Eₙ₋₁ closest to the phosphor screen is supplied with voltage higher than that of the phosphor screen. For example, Vₙ=5 kV-30 kV, and Vₙ₋₁=6 kV-35 kV. It should be understood, although not specifically shown, that this can be obtained for example by providing electrical connection between the phosphor screen electrode and one of the electrodes preceding electrode Eₙ₋₁.

FIG. 2B shows the electric field lines in the vacuum gap between photocathode 14 and phosphor screen 16. As shown, the voltage supply unit presenting the charged particle control unit creates such an electric field in the tube which, on the one hand, accelerates the emitted electrons towards phosphor screen 16 (the electrons energy at locations Zₙ₋₁ is already high enough to overcome the decelerating field), and on the other hand is a reverse field for positive ions in the vicinity of phosphor screen 16 thus accelerating the ions back to the phosphor screen. This avoids or at least significantly reduces the ions flow towards the photocathode.

FIG. 2C shows the voltage profile along the Z-axis for the conventional intensifier tube configuration (dashed curve) and for the above-described configuration (solid curve). FIG. 2D exemplifies the voltage profile along the X-axis in the vicinity of the phosphor screen, namely at locations Zₙ₋₁(Vₙ₋₁=25 kV) and Zₙ(Vₙ=20 kV) for the operative position of the above described device. In this device, V(X, Z=Zₙ₋₁)>Vₙ thus ions are accelerated back to the phosphor screen.

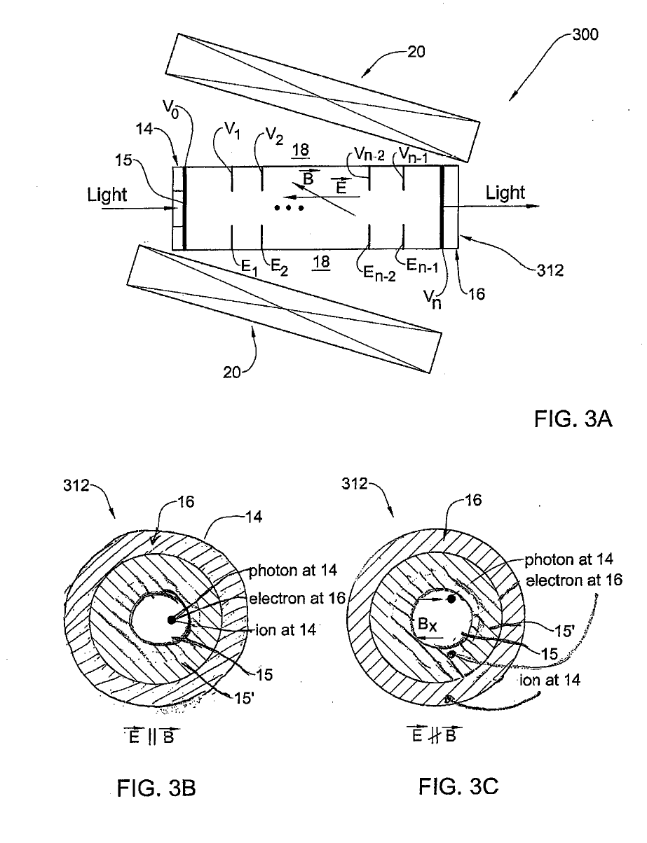

Reference is made to FIG. 3A showing schematically another example of the configuration of an image intensifier device 300, where a charged particle control unit 20 includes an external field source preventing ions propagation to the electrons' emitting region (active region) of a photocathode. Device 300 includes a vacuum tube 312 containing a photocathode unit 14 and a phosphor screen unit 16, and also preferably containing an array of apertured electrodes E₁-Eₙ₋₁, all associated with a voltage supply unit (not shown). Voltage supply to all the electrodes may and may not utilize the above-described concept, for example V₀<V₁<V₂< . . . <Vₙ₋₁>Vₙ. Photocathode 14 has an active region 15, namely region exposed to light (i.e. that region of the photocathode which is to be protected from being damaged by ions), surrounded by a non-active region 15′ (not illuminated) of the photocathode. Vacuum tube 312 is accommodated in a magnetic field region 18 created by an external magnetic field source 20. In the present example, magnetic field source 20 operates also as the charged particle control unit. To this end, magnetic field source 20 is configured and operable to create a magnetic field vector \vec{B} directed along an axis forming a certain non-zero angle (i.e. tilted) with respect to an electric field \vec{E} defined by the electrons propagation in the tube. This tilted magnetic field vector directs ions, originated at the phosphor screen towards outside the active region 15 of photocathode 14. This is illustrated more specifically in FIGS. 3B and 3C viewing schematically the tube 312 from the screen side. To facilitate illustration, phosphor screen unit 16 is showing of larger cross-sectional dimension than photocathode unit 14. As shown in FIG. 3B, with the magnetic and electric field vectors \vec{B} and \vec{E} parallel to each other, propagation axes of an input photon originating an electron beam from active region 15 of photocathode 14, that of the electron beam hitting phosphor screen 16 and of a corresponding ion beam hitting photocathode 14 are coinciding; accordingly, the ion beam hits the photocathode at its active region (were the photons are illuminating it). As shown in FIG. 3C, when applying a magnetic field with the magnetic field vector \vec{B} appropriately tilted with respect to the electric field \vec{E}, the photon, electron and ion beams propagation axes are shifted with respect to each other thus directing the ion beam towards outside the active region 15 of the photocathode, i.e. to non-active region 15′ of the photocathode. Turning back to FIG. 3A, such a tilted magnetic field may be created by appropriately accommodating the coils of magnetic field source with respect to the longitudinal axis of tube 312.

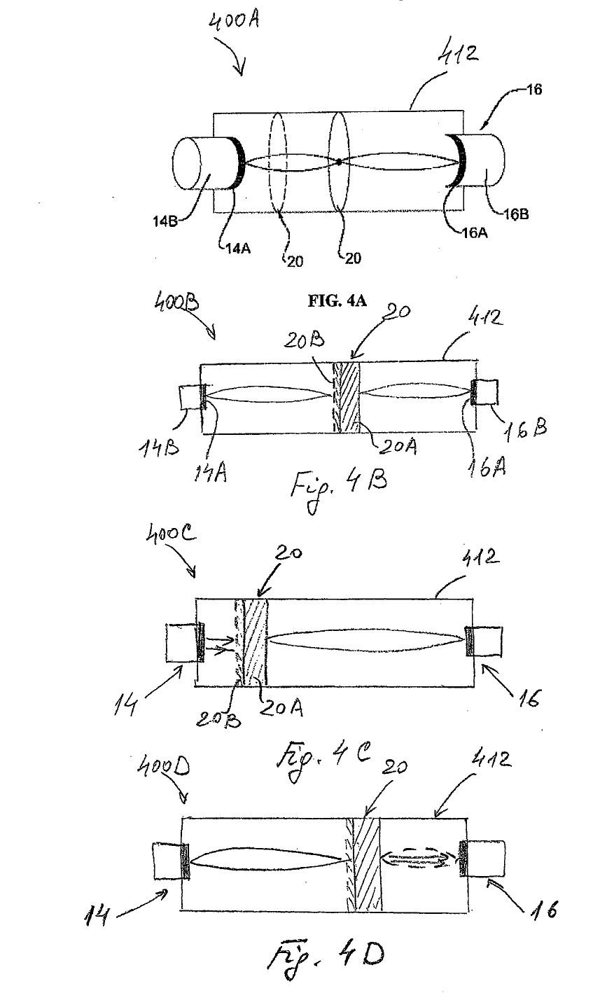

Referring to FIGS. 4A to 4D, there are shown yet other examples of an image intensifier device of the present invention configured to increase the lifetime of a multialkali photocathode.

Device 400A of FIG. 4A is configured as a magnetically focused image intensifier, and includes a vacuum tube 412 accommodated in the magnetic field region of an external magnetic field source (not shown here). Vacuum tube 412 includes a photocathode unit 14 (typically a multialkali photocathode layer 14A on a glass substrate 14B) and a phosphor screen unit 16 (phosphor layer structure 16A on a glass substrate 16B). It should be noted, although not specifically shown, that device 400A may also include an array of apertured electrodes as described above. Also provided in the tube is an ion barrier film (IBF) structure 20 accommodated between photocathode 14 and phosphor screen 16. This IBF 20 is a thin film made of aluminum, carbon, silicon, silicon oxide etc. The IBF 20 might be self supported or sitting on a low fill factor mesh. The IBF thickness is about 10 s of nanometers (e.g. ˜30 nm). The IBF 20 is preferably located either in the middle area of the tube, or closer to the photocathode (at a distance of about 200-500 μm) as shown in the figure in dashed lines. Electrons propagating from the photocathode have enough energy to pass through IBF 20, while ions are too large to pass therethrough. Hence, IBF 20 acts as a charged particle control unit in that it blocks the ion flow, coming from the phosphor screen and prevents ions from reaching the photocathode. The IBF 20 also stops the gasses existing in the vacuum tube, thus protecting the image intensifier from the 2^{nd} order damage mechanism.

Device 400B of FIG. 4B is also configured as a magnetically focused image intensifier, and includes a multialkali photocathode layer 14A on a glass substrate 14B, a phosphor layer structure 16A on a glass substrate 16B, and a charged particle control mechanism 20. The latter includes a microchannel plate (MCP) 20A, and preferably also an IBF structure 20B located between the MCP and the photocathode, for example attached to the respective surface of the MCP. The use of an IBF is advantageous, since it prevents an ion flow exiting the MCP towards the photocathode. This ion flow might be a result of ionization of free gas near the MCP surface when hit by high energy (about 200 eV) electrons. Considering ion control unit 20 formed by MCP 20A and IBF 20B, the operational parameters may be as follows: a 800 V potential difference between the photocathode and the MCP (instead of 200 V typically used in the “third generation” image intensifiers); a 5-7 kV potential difference between the MCP and the phosphor screen; and about 200-1500 V at the MCP.

An image intensifier device 400C of FIG. 4C includes a photocathode layer 14A (e.g., multialkali photocathode) on a glass substrate 14B, a phosphor layer structure 16A on a glass substrate 16B, and a charged particle control mechanism 20 formed by an MCP 20A and possibly also an IBF 20B. In this example, control unit 20 (MCP, or MCP with IBF) is accommodated close to photocathode 14B, the device thus operating with both proximity and magnetically focused device: proximity focus at the photocathode-MCP part of the device and magnetically focus at the MCP-screen part of the device.

Device 400D of FIG. 4D is configured generally similar to the above described device, but utilizing a charged particle control unit 20 (MCP 20A, or MCP 20A with IBF 20B) accommodated at a higher distance from the photocathode thus implementing a magnetically focus diode at the photocathode-MCP part of the device. As for the MCP-screen part it may also be configured as a magnetically focus diode, or as a proximity diode.

Thus, the present invention provides for appropriately affecting the flow of charged particles (ions), originated at the phosphor screen, towards the photocathode so as to prevent them from reaching the photocathode plane (as exemplified in FIGS. 2A-2D and FIGS. 4A-4D) or from reaching an active region within the photocathode plane (as exemplified in FIGS. 3A-3C). This effect significantly increases the lifetime of the photocathode which is essential in various applications, e.g., automatic inspection of articles (e.g. wafers) progressing along a production line, where the lifetime of photocathode in image intensifier(s) used in the inspection system is one of the factors affecting the throughput of the production line (the high throughput requires long lifetime image intensifier since it requires continuous high power image intensifier).

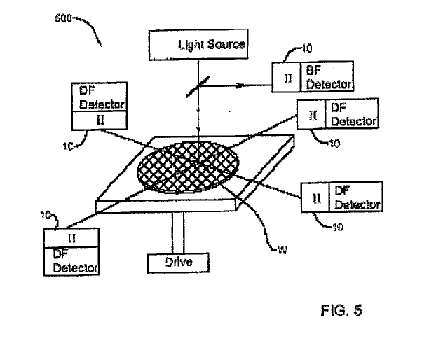

FIG. 5 schematically shows an example of an automatic inspection system, generally at 500 for inspecting semiconductor wafers W. System 500 includes a light source unit, a light detection unit, and appropriate light directing/collecting means. In the present example, system 500 is configured to operate in dark-field inspection mode using multiple dark-field detectors, and also in bright-field inspection mode. The principles of dark- and bright-field inspection are known per se and therefore need not be specifically described, except to note the following. In system 500, all the detection units collect radiation scattered from a common area on the wafer surface, and each one of the dark-field detection units is configured to collect the radiation along a different angular axis (i.e., a different elevation and/or azimuth). Each detection unit includes an image intensifier device 10 of the present invention (e.g. configured as either one of the above-described examples) accommodated in front of a respective light detector.

What is claimed is:

1. An image intensifier comprising: a photocathode unit having an active region adapted to convert light to electrons; a luminescent screen unit adapted to convert electrons emitted from the photocathode unit to light while generating ions; and a charge particle control unit adapted to direct electrons from the photocathode unit towards the luminescent screen unit while substantially preventing the generated ions to reach at least the active region of the photocathode unit.

2. The device of claim 1, comprising a plurality of apertured electrodes, E₁-Eₙ₋₁, arranged in a spaced-apart substantially parallel relationship along a vacuum space between the photocathode unit and the luminescent screen unit defining a channel for the electrons propagation from the photocathode to the luminescent screen unit, said plurality of apertured electrodes being maintained at voltages, V₁-Vₙ₋₁, gradually increasing in a direction towards the luminescent screen unit location.

3. The device of claim 1, wherein said charge particle control unit comprises a field source to create an external field preventing the ions propagation to at least the active region of the photocathode.

4. The device of claim 3, wherein said charge particle control unit is adapted to create an electric field profile in the tube directing the ions back to the screen unit.

5. The device of claim 4, comprising a plurality of apertured electrodes, E₁-Eₙ₋₁, arranged in a spaced-apart substantially parallel relationship along a vacuum space between the photocathode unit and the luminescent screen unit defining a channel for the electrons propagation from the photocathode to the luminescent screen unit, said plurality of apertured electrodes being maintained at voltages, V₁-Vₙ₋₁, gradually increasing in a direction towards the luminescent screen unit location, said charge particle control unit including a voltage supply unit configured and operable to provide voltage Vₙ of the luminescent screen unit lower than voltage Vₖ at the k-th apertured electrode where n>k, thereby accelerating the ions back to the screen unit.

6. The device of claim 5, wherein the voltage supply unit is configured and operable to supply voltage Vₙ₋₁ to the apertured electrode Eₙ₋₁ closest to the luminescent screen unit higher than voltage Vₙ of the screen unit, thereby accelerating the ions back to the screen unit.

7. The device of claim 3, wherein said charge particle control unit comprises a magnetic field source creating said magnetic field region, the magnetic field source being configured and operable to create a magnetic field vector directed along an axis forming a certain non-zero angle with an electric field vector created by the electrons flow from the photocathode towards the luminescent screen unit, thereby directing the ions originated at the luminescent screen unit towards outside said active region of the photocathode.

8. The device of claim 2, wherein said charge particle control unit comprises a magnetic field source creating said magnetic field region, the magnetic field source being configured and operable to create a magnetic field vector directed along an axis forming a certain non-zero angle with an electric field vector created by the electrons flow from the photocathode towards the luminescent screen unit, said magnetic field thereby directing ions originated at the luminescent screen unit towards outside said active region of the photocathode.

9. The device of claim 1, wherein said charge particle control unit comprises an ion barrier film structure accommodated between the photocathode and the luminescent screen unit and configured to block the ions and gasses propagating from the luminescent screen unit.

10. The device of claim 9, wherein said photocathode unit includes a multialkali photocathode layer.

11. The device of claim 1, wherein said photocathode unit includes a multialkali photocathode layer.

12. The device of claim 11, wherein said charge particle control unit comprises an electron multiplier accommodated in the path of electrons propagating from the photocathode unit to the luminescent screen unit, thereby increasing the lifetime of the multialkali photocathode.

13. The device of claim 12, wherein said electron multiplier comprises a microchannel plate.

14. The device of claim 12, wherein said charge particle control unit comprises an ion barrier film structure accommodated between the photocathode and the electron multiplier and configured to block ions and gasses propagating towards the photocathode in a direction from the electron multiplier, thereby increasing the lifetime of the multialkali photocathode.

15. The device of claim 12, configured as a double magnetically focused diode at the first device part between the photocathode unit and the electron multiplier and the second device part between the electron multiplier and the luminescent screen unit.

16. The device of claim 1, wherein said charge particle control unit comprises an electron multiplier accommodated close to the photocathode unit in the path of electrons propagating from the photocathode unit to the luminescent screen unit, thereby operating as a proximity diode at the device part between the photocathode unit and the electron multiplier.

17. The device of claim 16, wherein said charge particle control unit comprises an ion barrier film structure accommodated between the photocathode and the electron multiplier and configured to block ions and gasses propagating towards the photocathode in a direction from the electron multiplier.

18. The device of claim 1, wherein said charge particle control unit comprises an electron multiplier accommodated in the path of electrons propagating from the photocathode unit to the luminescent screen unit, the device being configured and operable as a double magnetically focused diode at the first device part between the photocathode unit and the electron multiplier and the second device part between the electron multiplier and the luminescent screen unit.

19. The device of claim 1, wherein said charge particle control unit comprises an electron multiplier accommodated in the path of electrons propagating from the photocathode unit to the luminescent screen unit closer to the luminescent screen unit, the device being configured and operable as a magnetically focused diode at the first device part between the photocathode unit and the electron multiplier and as a proximity focus diode at the second device part between the electron multiplier and the luminescent screen unit.

20. A magnetically focused image intensifier device comprising a photocathode unit having an active region adapted to convert light to electrons, and a luminescent screen unit adapted to convert electrons emitted from the photocathode unit to light while generating ions, the device comprising a charge particle control unit configured and operable to create an external field directing electrons from the photocathode unit towards the luminescent screen unit while substantially preventing the generated ions from reaching at least the active region of the photocathode, thereby increasing the lifetime of the photocathode.

21. A magnetically focused image intensifier device comprising a vacuum tube for accommodating in a magnetic field region, the vacuum tube comprising:
a photocathode unit adapted to convert input light to electrons,
a luminescent screen unit adapted to convert electrons emitted by the photocathode to output light while generating ions,
a plurality of apertured electrodes E₁-Eₙ₋₁ arranged in a spaced-apart substantially parallel relationship along said vacuum tube between the photocathode unit and the luminescent screen unit defining a channel for the electrons propagation from the photocathode to the luminescent screen unit, and
a voltage supply unit adapted to maintain certain voltages at the photocathode, said plurality of apertured electrodes, and the screen unit, such that the voltage values gradually increase in a direction from the photocathode towards the screen unit and the screen unit voltage Vₙ is lower than that voltage Vₖ at the k-th apertured electrode where n>k; the electric potential profile thus created directing the electrons from the photocathode unit towards the luminescent screen unit while directing ions originated at the luminescent screen unit back to the screen unit thereby preventing them from reaching the photocathode.

22. A magnetically focused image intensifier device comprising a magnetic field source creating a magnetic field region, a photocathode unit having an active region adapted to convert input light to electrons and a luminescent screen unit adapted to convert electrons emitted from the photocathode unit to output light while generating ions, said magnetic field source being configured and operable to create a magnetic field vector directed along an axis forming a certain non-zero angle with an electric field vector created by the electrons flow from the photocathode towards the luminescent screen unit, thereby directing ions originated at the luminescent screen unit towards outside said active region of the photocathode and preventing the ions from reaching said active region.

23. An image intensifier device comprising a photocathode unit having a multialkali photocathode layer and adapted to convert input light to electrons, a luminescent screen unit adapted to convert electrons emitted from the photocathode unit to output light while generating ions, and an ion barrier film structure accommodated between the photocathode and the luminescent screen units and configured to block ions propagating from the luminescent screen unit thereby preventing them from reaching the photocathode.

24. An image intensifier device comprising a photocathode unit having a multialkali photocathode layer and adapted to convert input light to electrons, a luminescent screen unit adapted to convert electrons emitted from the photocathode unit to output light, and an ion barrier film structure accommodated between the photocathode and the luminescent screen units and configured to block gasses thereby preventing them from reaching the photocathode.

25. An image intensifier device comprising a photocathode unit having a multialkali photocathode layer and adapted to convert input light to electrons, a luminescent screen unit adapted to convert electrons emitted from the photocathode unit to output light, and an electron multiplier accommodated in the path of electrons propagating from the photocathode unit to the luminescent screen unit, the device being thereby characterized by increased lifetime of the multialkali photocathode.

26. An image intensifier device comprising a photocathode unit having a multialkali photocathode layer and adapted to convert input light to electrons, a luminescent screen unit adapted to convert electrons emitted from the photocathode unit to output light, an electron multiplier accommodated in the path of electrons propagating from the photocathode unit to the luminescent screen unit, and an ion barrier film structure accommodated between the photocathode and the electron multiplier and configured for blocking ions and gasses thereby preventing them from reaching the photocathode, the device being thereby characterized by increased lifetime of the multialkali photocathode.

27. A magnetically focused image intensifier device comprising a photocathode unit adapted to convert light to electrons, a luminescent screen unit adapted to convert electrons emitted from the photocathode unit to light while generating ions, and an electron multiplier accommodated in the path of electrons propagating from the photocathode unit to the luminescent screen unit, the device defining a magnetically focus diode arrangement in at least one of the following paths: the path between the photocathode and the electron multiplier, and the path between the electron multiplier and the luminescent screen unit.

28. A method for increasing a lifetime of a photocathode in an image intensifier device, which includes a photocathode unit adapted to convert light to electrons and a luminescent screen unit adapted to convert electrons emitted from the photocathode unit to light while generating ions, the method comprising: providing a charge particle control unit adapted to direct electrons from the photocathode unit towards the luminescent screen unit while substantially preventing the generated ions to reach at least the active region of the photocathode unit.

29. A method for increasing a lifetime of a multialkali photocathode in an image intensifier device, which includes a photocathode unit adapted to convert light to electrons and a luminescent screen unit adapted to convert electrons emitted from the photocathode unit to light while generating ions, the method comprising providing an electron multiplier in the path of electrons propagating from the photocathode unit to the luminescent screen unit.

30. A method for increasing a lifetime of a photocathode in a magnetically focused image intensifier device, which includes a photocathode unit adapted to convert light to electrons and a luminescent screen unit adapted to convert electrons emitted from the photocathode unit to light while generating ions, the method comprising providing an electron multiplier in the path of electrons propagating from the photocathode unit to the luminescent screen unit.

31. An optical system for use in automatic inspection of articles progressing along a production line, the system comprising at least one light detection unit, the light detection unit comprising a light detector for detecting a light response of the article to incident electromagnetic radiation, and a magnetically focused image intensifier accommodated in an optical path of light propagating from the article to the light detector, the image intensifier comprising: a photocathode unit having an active region adapted to convert light to electrons; a luminescent screen unit adapted to convert electrons emitted from the photocathode unit to light while generating ions; and a charge particle control unit adapted to direct electrons from the photocathode unit towards the luminescent screen unit while substantially preventing the generated ions to reach at least the active region of the photocathode unit, thereby increasing the lifetime of the photocathode and throughput of the production line.
